(19) United States
(12) Patent Application Publication
(10) Pub. No.: US 2006/0117114 A1
(43) Pub. Date: Jun. 1, 2006

(54) Staggering memory requests

(76) Inventors: Rohit R. Verma, San Jose, CA (US); Muraleedhara Herur Navada, Santa Clara, CA (US); Miguel A. Guerrero, Fremont, CA (US); Ashwani Oberai, Milpitas, CA (US)

Correspondence Address: Grossman, Tucker, Perreault & Pfleger, PLLC;Portfolio IP, P.O. Box 52050, Minneapolis, MN, 55402, US

(21) Appl. No.: 10/998,860

(22) Filed: Nov. 29, 2004

(51) Int. Cl. G06F 3/00

(52) U.S. Cl. 710/5

(57) ABSTRACT

A method according to one embodiment may include transmitting a plurality of packets through control pipeline circuitry of an integrated circuit of a switch. The control pipeline circuitry may be capable of making a plurality of memory requests to memory of the switch in response to the plurality of packets. The method may further comprise staggering the plurality of memory requests so that each of the plurality of memory requests occurs during a different one of a plurality of time slots. Of course, many alternatives, variations, and modifications are possible without departing from this embodiment.

### BACKGROUND

Computer nodes may communicate with each other via one or more communication networks. Each node may function as a transmitting (source) and receiving (destination) device in order to exchange data and/or commands with each other using different communication protocols. Data and/or commands may be divided by the communication protocol into smaller packets of information for more efficient routing. Each packet may have a particular format and size.

A switch may be utilized to facilitate communication within and between networks by routing packets between computer nodes. Some switches may utilize a store and forward architecture. That is, the switch receives the whole packet before forwarding it to its destination. By waiting for the end of the packet, a store and forward switch may perform various operations on the packet to ensure that a correct packet is available for transmission before sending a corrupted or truncated packet to a receiving device.

A store and forward switch may include a control pipeline having a plurality of units in a control data path to perform a variety of operations on each packet. The packets may flow through such units in a serial fashion. Some of the operations performed by some of the units may require access to memory, e.g., for accessing tables or rules. However, these units may be arranged in a deeply pipelined architecture with un-deterministic latencies for the various units. Therefore, buffers, e.g., first-in, first-out (FIFO) buffers, were placed at the interface of each of the units to account for the varying latencies and buffers were also placed between the units and memory.

As any one of the buffers reached a full data condition, it provided a backpressure signal representative of this full data condition. In response, the switch would then stall the flow of packets through the control pipeline. The flow of packets would then later be recovered once the particular buffer was sufficiently emptied. These buffers and associated full data conditions create complex validation efforts which lead to increased design and production time for such switches. In addition, each unit of the control pipeline and particular sub-units within each unit may try to fetch data from memory via a plurality of unrelated memory requests. Hence, complex arbitration is required to arbitrate among all these unrelated memory requests. Increased waiting time for the various units and sub-units may also result, which may lead to underutilization of such units and a degradation of overall efficiency.

### BRIEF DESCRIPTION OF THE DRAWINGS

FIG. 1 is a block diagram of a switch having an integrated circuit consistent with an embodiment;

FIG. 2 is a block diagram of the integrated circuit of FIG. 1;

FIG. 3 is block diagram of the address resolution unit circuitry and address memory controller of the integrated circuit of FIG. 2;

FIG. 4 is a timing diagram illustrating the staggering of memory requests from components of FIG. 3; and

FIG. 5 is a flow chart illustrating operations that may be performed according to an embodiment.

### DETAILED DESCRIPTION

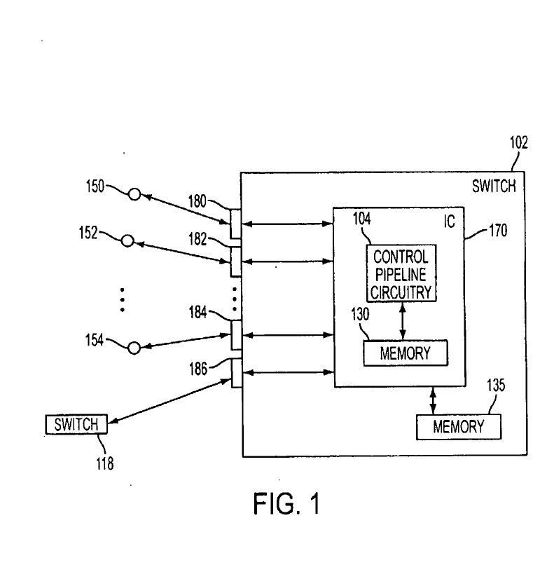

FIG. 1 is a block diagram of a system including a switch 102 to facilitate communication of data and/or commands among the plurality of computer nodes 150, 152, 154. Computer nodes 150, 152, 154 may be coupled to ports 180, 182, 184, respectively, of the switch 102. Switch 102 may facilitate communication among the computer nodes 150, 152, 154 which may be in the same local area network (LAN). The switch 102 may also facilitate communication with other switches, e.g., switch 118, and with other networks so that local computer nodes 150, 152, 154 may communicate with any number of computer nodes over other networks as well.

Each computer node may function as a transmitting (source) and receiving (destination) device in order to exchange data and/or commands with each other via the switch 102 using one or more of a variety of communication protocols. Each computer node 150, 152, 154 may include personal computers and servers. Such data and/or commands may be divided by the communication protocol into smaller packets of information for more efficient routing. Each packet may have a particular format and size including information such as the address of the destination device.

One communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Another communication protocols may include the X.25 communications protocol. The X.25 communication protocol may comply or be compatible with a standard promulgated by the International Telecommunication Union-Telecommunication Standardization Sector (ITU-T). Another communication protocol may be a frame relay communication protocol. The frame relay communications protocol may comply or be compatible with a standard promulgated by Consultative Committee for International Telegraph and Telephone (CCITT) and/or the American National Standards Institute (ANSI). Yet another communication protocol may be an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed communications protocols are equally contemplated herein.

The plurality of ports 180, 182, 184, 186 may be capable of receiving and transmitting a plurality of packets to the computer nodes 150, 152, 154 and other computer nodes of other networks, e.g., via switch 118 coupled to port 186. The switch 102 may include an integrated circuit (IC) 170 and the IC may further include control pipeline circuitry 104 and memory 130. As used herein, an “integrated circuit” or IC means a semiconductor device and/or microelectronic device, such as, for example, a semiconductor integrated circuit chip. As used herein, “circuitry” may comprise, for example, singly or in any combination, hardwired circuitry, programmable circuitry, state machine circuitry, and/or firmware that stores instructions executed by programmable circuitry. The IC 170 may be capable of receiving and transmitting those packets received by the plurality of ports to appropriate computer nodes or other switches.

In general, the IC 170 may route received packets through the control pipeline circuitry 104. The control pipeline circuitry 104 may perform various operations on such received packets such as address resolution, rule lookups, and traffic prioritization before storing and/or forwarding the packet on to the appropriate destination. Some of the operations performed by the control pipeline circuitry 104 may require access to information stored in memory 130. Memory 130 may include one or more machine readable storage media such as random-access memory (RAM), dynamic RAM (DRAM), static RAM (SRAM) magnetic disk (e.g. floppy disk and hard drive) memory, optical disk (e.g. CD-ROM) memory, and/or any other device that can store information.

The switch 102 may also comprise memory 135. Memory 135 may be external to IC 170. Memory 135 may comprise one or more of the following types of memories: semiconductor firmware memory, programmable memory, non-volatile memory, read only memory, electrically programmable memory, random access memory, flash memory such as NAND or NOR type flash memory, magnetic disk memory, and/or optical disk memory. Machine readable firmware program instructions may be stored in memory 135. These instructions may be accessed and executed by the integrated circuit 170. When executed by the integrated circuit 170, these instructions may result in the integrated circuit 170 performing the operations described herein as being performed by the integrated circuit.

The integrated circuit 170 may stagger a plurality of memory requests to memory so that each of the plurality of memory requests occurs during a different time slot. For example, memory requests from the control pipeline circuitry 104 to memory 130 may be staggered so that each memory request occurs during a different time slot.

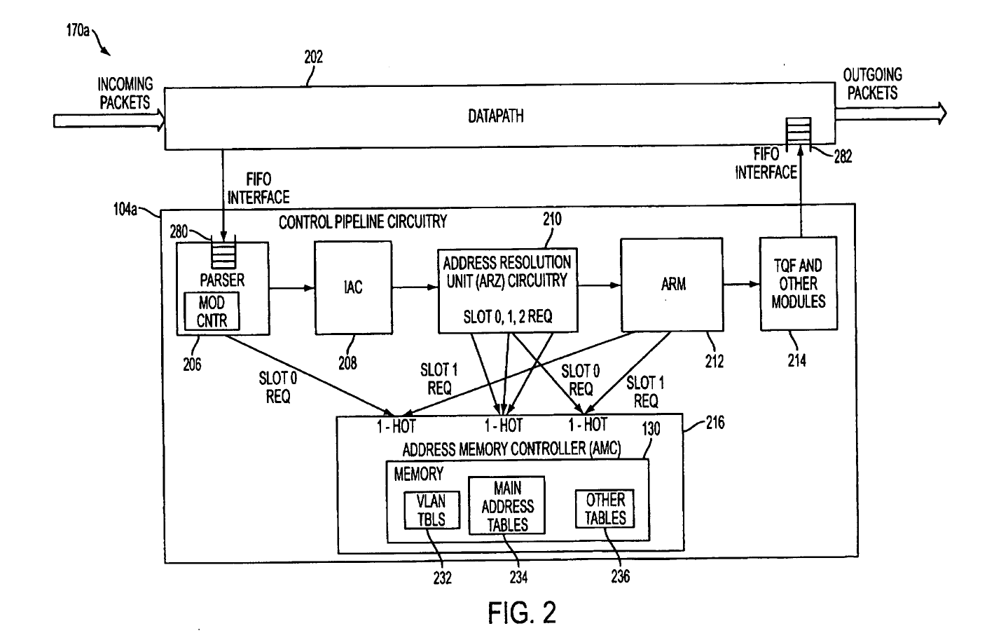

FIG. 2 is a block diagram of one embodiment of an IC 170a and control pipeline circuitry 104a that may be used in the switch 102 of FIG. 1. The control pipeline circuitry 104a may include units 206, 208, 210, 212, and 214, where each unit may comprise circuitry to perform a variety of operations on received packets. Such units 206, 208, 210, 212, and 214 and/or sub-units within each unit may make memory requests to memory 130 of the address memory controller 216 for information stored therein based on a type of packet passing through the sub-unit or unit. Accordingly, a plurality of memory requests may be made to memory 130 and such memory request may be staggered so that each of the memory requests occurs during a different time slot. Hence, arbitration of such memory requests may be greatly simplified.

The IC 170a may also include a data path 202 to accept incoming packets and provide outgoing packets. A buffer, e.g., a first-in, first-out (FIFO) buffer 280 may be at an input to the control pipeline circuitry 104a to temporarily store and assemble incoming packets and another FIFO buffer 282 may be used at an output from the control pipeline circuitry 104a.

The various units 206, 208, 210, 212, and 214 of the control pipeline circuitry 104a may include a parser unit 206, an ingress access control (IAC) unit 208, an address resolution unit (ARZ) 210, an applied rules manager (ARM) unit 212, and a transmit queue formatter (TQF) unit 214. The parser unit 206 may parse incoming packets into associated fields, e.g., source address fields and destination address fields. The parser unit 206 generally does not need access to memory 130 to perform its parsing operations, but can rather perform such operations from examining the content of the packet. The ingress access control unit 208 may receive information from the parser unit 206 and decide whether to allow such information to travel further along the control pipeline circuitry 104a or to drop such information.

The address resolution unit circuitry 210, with knowledge of the fields from the parser unit 206 may perform associated lookups such as source, destination, and rule lookups. The address resolution unit circuitry 210 accordingly may need to accesses memory 130 of the address memory controller 216. The applied rules manager unit 212 may apply rules that were obtained from the address resolution unit 210. Finally, the transmit queue formatter unit 214 finishes processing of packets for eventual transmission to an appropriate destination computer node or nodes.

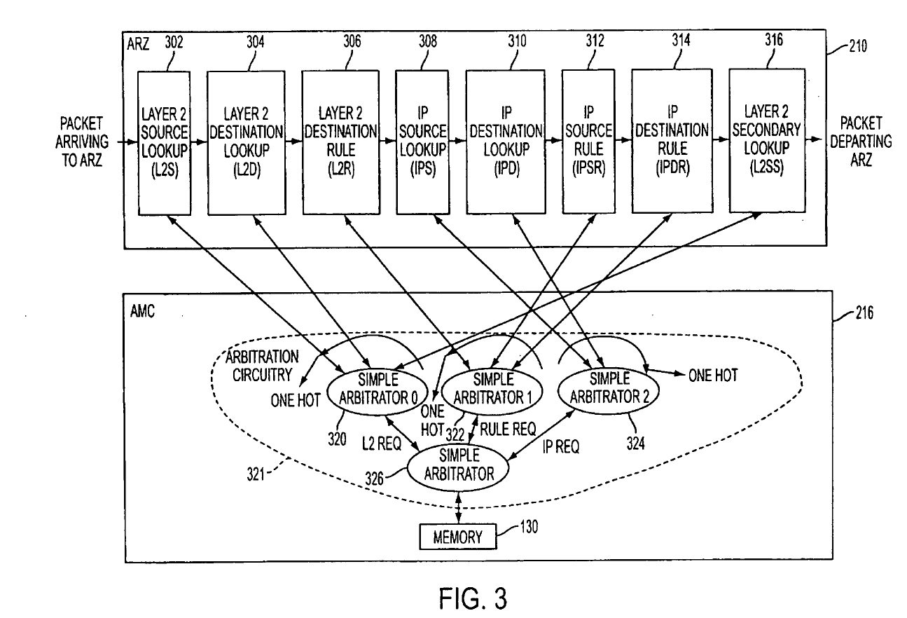

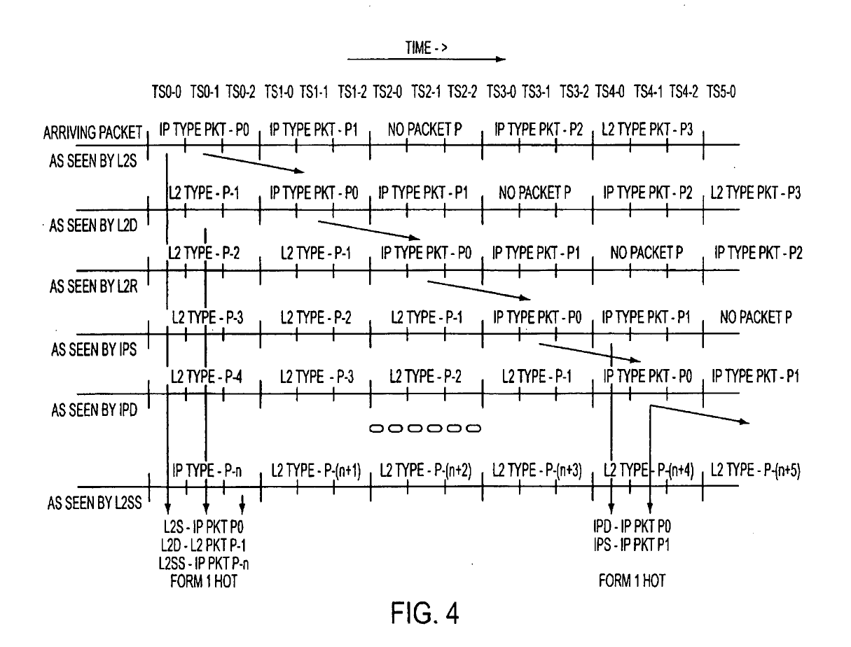

The various units 206, 208, 210, 212, and 214 may apply their various operations to the incoming packets in a serial fashion one after the other. Again, some of the units such as the address resolution unit circuitry 210 may need access to information stored in memory 130. Such information may be stored in a variety of formats including tables such as virtual local area network (VLAN) tables 232, main address tables 234, or other tables 236. Such tables may be maintained by protocol agents and updated as necessary. Each unit 206, 208, 210, 212, and 214 may also include a plurality of sub-units which may make memory request commands to memory 130 to access information stored therein. These memory requests may be staggered so each memory request from each sub-unit occurs during a different time slot. Hence, arbitration of such memory requests may be greatly simplified or even eliminated. Although such staggering of memory requests is detailed herein with reference to the address resolution unit circuitry 210 and FIGS. 3 and 4, such staggering is also applicable to other parts and units of the control pipeline circuitry 104a.

FIG. 3 is a block diagram of the address resolution unit circuitry 210 and the address memory controller 216 of FIG. 2. The address resolution unit circuitry 210 may include a plurality of sub-units. The plurality of sub-units may include Layer2 Source Lookup (L2S) circuitry 302, Layer2 Destination Lookup (L2D) circuitry 304, Layer2 Destination Rule circuitry (L2R) 306, Internet Protocol (IP) Source Lookup (IPS) circuitry 308, IP Destination Lookup (IPD) circuitry 310, IP Source Rule (IPSR) circuitry 312, IP Destination Rule (IPDR) circuitry 314, and Layer2 Secondary Lookup (L2SS) circuitry 316. L2S circuitry 302 may perform Layer 2 source lookup which may be one operation of packet classification. Other sub-unit circuitries may perform other source, destination, or rule lookups for Layer 2 or IP type packets. The address memory controller 216 may include arbitration circuitry 321 and memory 130. The arbitration circuitry 321 may include a plurality of simple arbitration circuitries 320, 322, 324, and 326.

The packets may travel through the plurality of sub-units 302, 304, 306, 308, 310, 312, 314, and 316 in a serial fashion. The integrated circuit 170a may control data flow of received packets through the plurality of sub-units to a deterministic flow rate as the received packets flow through the sub-units 302, 304, 306, 308, 310, 312, 314, and 316 one after another in different time slots. The plurality of sub-units may then stagger their memory requests to memory 130 so that each memory request from any of the sub-units 302, 304, 306, 308, 310, 312, 314, and 316 occurs during a different time slot. Hence, the efficiency and speed of memory access to memory 130 by the various sub-units 302, 304, 306, 308, 310, 312, 314, and 316 may be increased.

The sub-units 302, 304, 306, 308, 310, 312, 314, and 316 may or may not make such memory requests to memory 130 to access information therein depending on at least the presence of a packet in the particular sub-unit during a particular time and, if present, the type of such packet. For example, L2S circuitry 302, L2D circuitry 304, and L2R circuitry 306 may make. memory requests for Layer 2 type packets, while IPS, IPD, IPSR, IPDR, L2S and L2SS circuitry may make memory requests for IP type packets.

FIG. 4 is a timing diagram illustrating how memory requests from particular sub-units 302, 304, 306, 308, 310, 312, 314, and 316 of FIG. 3 may be staggered so that only one memory request occurs during an associated time slot as received packets flow through each of the sub-units at a deterministic flow rate. A variety of time slots TS0-0, TS0- 1, TS0-2, TS1-0, TS1-1, TS1-2, TS2-0, etc. are illustrated. Each time slot may be selected to equal the length of one cycle of the operating clock frequency of the control pipeline circuitry 104a of the IC 170a. For example, if such clock frequency is 250 megahertz (MHz), each time slot may be set to 4,000 picoseconds (ps).

The deterministic flow rate may be based on the maximum arrival rate of packets to the switch. For instance, if the switch 102 has 24-1 gigabit/second ports and 2-10 gigabit/second ports a maximum amount of data that may arrive is 44 gigabits per second (Gb/s). This maximum data arrival rate converts to a maximum packet arrival rate of about 66 million packets per second assuming about 80 bytes per packet. The maximum packet arrival rate may then be converted to a packet per time slot value knowing the length of each time slot. For example, in one embodiment with a maximum arrival rate of about 66 million packets per second, each sub-unit (for example, sub units 302, 304, 306, 308, 310, 312, 314, and 316) would need to process two packets every six time slots or one packet every three time slots.

If the actual packet traffic arriving is less than the maximum arrival rate, a corresponding amount of time slots may be empty of any packets. For example, if the actual packet traffic arriving is half of the maximum arrival rate of 66 million packets per second or 33 million packets per second, only 50% of the available time slots would contain packets and the other time slots would be empty. As another example, FIG. 4 illustrates the L2S circuitry 302 may not see a packet in time slots TS2-0, TS2- 1, and TS2-2. Despite a varying amount of arriving packets and hence empty time slots, incoming packets may move through the control pipeline circuitry 104a at a deterministic flow rate, e.g., one packet every three time slots.

All packets may pass though each sub-unit 302, 304, 306, 308, 310, 312, 314, and 316 of FIG. 3 in serial fashion at the deterministic flow rate. For instance, packet “IP Type Pkt-P0” may be first seen by L2S circuitry 302 during the three time slots TS0-0, TS0-1, and TS0-2. This packet “IP Type Pkt-P0” may then be seen by L2D circuitry 304 during the next three time slots TS1-0, TS1-1, and TS1-2, and by L2R circuitry 306 during the next three time slots TS2-0, TS2-1 and TS2-2, and so on. Different sub-units may therefore see the same packet during time slots. This enables multiple packets to reside and be processed by different sub-units at different time intervals thereby improving performance.

Each sub-unit 302, 304, 306, 308, 310, 312, 314, and 316 may or may not make a memory request to memory 130 depending on the presence of a packet in any given time slot and the type of that packet if present. For example, if the incoming packet is a Layer 2 type packet, IPS circuitry 308 may not process such packet but may rather keep the packet for the applicable time slot and pass it on to the next IPD circuitry 310. Each sub-unit 302, 304, 306, 308, 310, 312, 314, and 316 may make a maximum of one memory request per packet. Advantageously, each of these memory requests may be staggered so that only one active memory request occurs in a certain time slot.

Simple arbitrator circuitry 320 may receive memory requests from L2S circuitry 302, L2D circuitry 304, and L2SS circuitry 316. Simple arbitrator circuitry 322 may receive memory requests from L2R circuitry 306, IPSR circuitry 312, and IPDR circuitry 314. Simple arbitrator circuitry 324 may receive memory requests from IPS circuitry 308 and IPD circuitry 310. Arbitrator circuitry 326 may then arbitrate among the simple arbitrators 320, 322, 324 to make requests to memory 130 for information stored therein.

The L2S circuitry 302, L2D circuitry 304, and L2SS circuitry 316 may make memory requests for different packets during the time slot TS0-X (TS0-0, TS0-1, or TS0-2). Advantageously, such circuitry staggers its memory requests so that each of these three memory requests occurs during three different time slots TS0-0, TS0-1, and TS0-2. For instance, L2S circuitry 302 may make a memory request for “IP Type Pkt-P0” during time slot TS0-0. L2D circuitry 304 may make a memory request for another packet or the “L2 Type-P-1” packet in time slot TS0-1, and L2SS circuitry 316 may make a memory request for yet another packet or the “IP Type-P-n” packet in time slot TS0-2. Therefore, the address memory controller 216 may see no more than one active or hot memory request per time slot. Similarly, the memory requests from L2R circuitry 306, IPSR circuitry 312, and IPDR circuitry 314 may be staggered into time slots TS1-0, TS1-1, and TS1-2 respectively. In addition, the memory requests from the IPS circuitry 308 and IPD circuitry 310 may also be staggered into different time slots.

Hence, the address memory controller 216 knowing the one active memory request can implement fast access to memory 130 as arbitration among memory requests may be greatly simplified or even eliminated. The memory 130 may provide the data requested in a predictable latency. The sub-units may therefore have to wait a predetermined time interval for data to be returned from memory 130. Delay lines (shifters) may be utilized to wait for the data from memory 130. In one instance, the latency delay for memory 130 to receive the memory request, look up the applicable data, and provide the applicable data back to the appropriate sub-unit may be about 14 cycles. In this instance, one time slot of delay may be added to align the latency to 15 time slots since 15 is evenly divisible by 3 (the deterministic packet rate of one packet per 3 time slots). Accordingly, there may be a fixed ratio of the clock for the control pipeline circuitry to the clock for memory 130.

If additional sub-units are added to the address resolution unit circuitry 210, such additional sub-units may be aligned with the modulo count to ensure one active memory request per time slot. For example, an L2 table in memory 130 may be access by L2S circuitry 302 and L2SS circuitry 316 during different modulo counts or time slots TS0-0 and TS0-2. If an additional sub-unit is added to the address resolution unit 210, these memory requests might not remain one active. Therefore, if one sub-unit is added a minimum number of stages may be added, e.g., 3, to ensure that all requests are aligned with the modulo-count. A plurality of dummy sub-units may be added initially and may be utilized to ensure alignment after changes may be made to the number of sub-units.

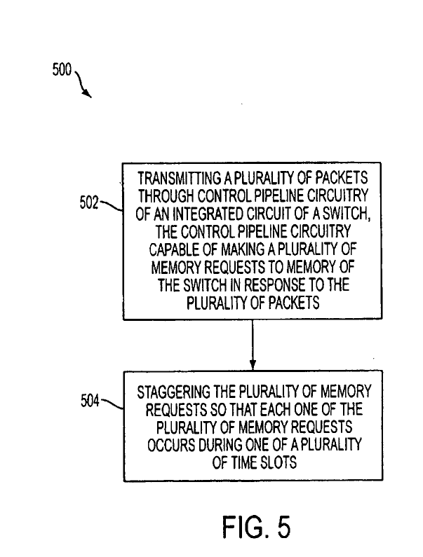

FIG. 5 is a flow chart of operations 500 consistent with an embodiment. Operation 502 may include transmitting a plurality of packets through control pipeline circuitry of an integrated circuit of a switch, the control pipeline circuitry capable of making a plurality of memory requests to memory of the switch in response to the plurality of packets. Operation 504 may include staggering the plurality of memory requests so that each of the plurality of memory requests occurs during a different one of a plurality of time slots.

It will be appreciated that the functionality described for all the embodiments described herein, may be implemented using hardware, firmware, software, or a combination thereof.

Thus, in summary, one embodiment may comprise a switch. The switch may comprise a plurality of ports capable of receiving a plurality of packets, and an integrated circuit capable of transmitting the plurality of packets through control pipeline circuitry of the integrated circuit. The control pipeline circuitry may be capable of making a plurality of memory requests to memory of the switch in response to the plurality of packets, and the control pipeline circuitry may be capable of staggering the plurality of memory requests so that each of the plurality of memory requests occurs during a different one of a plurality of time slots.

Another embodiment may comprise an article. The article may comprise a storage medium having stored therein instructions that when executed by a machine result in the following: transmitting a plurality of packets through control pipeline circuitry of a switch, the control pipeline circuitry capable of making a plurality of memory requests to memory of the switch in response to the plurality of packets; and staggering the plurality of memory requests so that each of the plurality of memory requests occurs during a different one of a plurality of time slots.

Advantageously, in these embodiments, staggering of the memory requests simplifies arbitration of such requests significantly and can even eliminate the need for arbitration. Hence, access to memory 130 may be achieved at high speeds enabling high performance of memory 130. In addition, the control pipeline circuitry 104a and/or portions thereof such as the address resolution unit circuitry 210 (including sub-unit circuitry therein) may move each of the plurality of packets through such circuitry at a deterministic flow rate, e.g., one packet per three time slots. Hence, each packet may take a predictable amount of time in particular circuitry, e.g., the sub-unit circuitries of the address resolution unit circuitry 210. In addition, each sub-unit circuitry may have a turn around time of only three time slots.

The consistent deterministic flow rate of incoming packets may also allow designers of such ICs to slot their requirements of hardware resources. With an initial design phase to ensure proper staggering of requests, the whole control pipeline may move at a predictable and deterministic rate. Hence, the pipeline may not need to stall as in a conventional embodiment when FIFO buffers between units become full. For example, buffers between units such as units 208 and 210 may be eliminated. The elimination of such buffers may also eliminate additional design complexity caused by such buffers and related stalls in the pipeline when such buffers reached a full data condition. A significant amount of tests relating to buffer overflow, stall and recovery conditions may now be eliminated.

Furthermore, memory requests may now be serviced in predictable deterministic latencies. The interfaces between the units 206, 208, 210, 212, and 214 may now become simple pipeline registers. The overall control path pipeline may also be validated in a much shorter time interval than a conventional embodiment.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method comprising:
transmitting a plurality of packets through control pipeline circuitry of an integrated circuit of a switch, said control pipeline circuitry capable of making a plurality of memory requests to memory of said switch in response to said plurality of packets; and
staggering said plurality of memory requests so that each of said plurality of memory requests occurs during a different one of a plurality of time slots.

2. The method of claim 1, wherein said transmitting operation comprises transmitting said plurality of packets through said control pipeline circuitry at a deterministic flow rate.

3. The method of claim 2, wherein said deterministic flow rate is based on a maximum arrival rate of said plurality of packets to said switch, and wherein a corresponding amount of said plurality of time slots are empty of any of said plurality of packets if an arrival rate of said plurality of packets is less than said maximum arrival rate.

4. The method of claim 3, wherein said deterministic flow rate is one of said plurality of packets per three of said plurality of time slots.

5. The method of claim 1, wherein said control pipeline circuitry comprises address resolution unit circuitry capable of requesting data from said memory in response to a type of each of said plurality of packets passing through said address resolution unit circuitry.

6. The method of claim 5, wherein said address resolution unit circuitry comprises Layer 2 source lookup (L2S) circuitry, Layer 2 destination lookup (L2D) circuitry, and Layer 2 Secondary lookup (L2SS) circuitry, said L2S circuitry making a first memory request for a first data packet during a first time slot, said L2D circuitry making a second memory request for a second data packet during a second time slot, and said L2SS circuitry making a third memory request for a third packet during a third time slot.

7. A switch comprising:
a plurality of ports capable of receiving a plurality of packets;
an integrated circuit capable of transmitting said plurality of packets through control pipeline circuitry of said integrated circuit, said control pipeline circuitry capable of making a plurality of memory requests to memory of said switch in response to said plurality of packets, and said control pipeline circuitry capable of staggering said plurality of memory requests so that each of said plurality of memory requests occurs during a different one of a plurality of time slots; and
flash memory coupled to said integrated circuit and comprising at least one instruction that is executed by said integrated circuit.

8. The switch of claim 7, wherein said integrated circuit is capable of transmitting said plurality of packets through said control pipeline circuitry at a deterministic flow rate.

9. The switch of claim 8, wherein said deterministic flow rate is based on a maximum arrival rate of said plurality of packets to said plurality of ports of said switch, and wherein a corresponding amount of said plurality of time slots are empty of any of said plurality of packets if an arrival rate of said plurality of packets is less than said maximum arrival rate.

10. The switch of claim 9, wherein said deterministic flow rate is one of said plurality of packets per three of said plurality of time slots.

11. The switch of claim 7, wherein said control pipeline circuitry comprises address resolution unit circuitry capable of requesting data from said memory in response to a type of each of said plurality of packets passing through said address resolution unit circuitry.

12. The switch of claim 11, wherein said address resolution unit circuitry comprises Layer 2 source lookup (L2S) circuitry, Layer 2 destination lookup (L2D) circuitry, and Layer 2 Secondary lookup (L2SS) circuitry, said L2S circuitry capable of making a first memory request for a first data packet during a first time slot, said L2D circuitry capable of making a second memory request for a second data packet during a second time slot, and said L2SS circuitry capable of making a third memory request for a third packet during a third time slot.

13. The switch of claim 7, wherein said plurality of packets comply with an Ethernet communication protocol.

14. An article comprising:
a storage medium having stored therein instructions that when executed by a machine result in the following:
transmitting a plurality of packets through control pipeline circuitry of a switch, said control pipeline circuitry capable of making a plurality of memory requests to memory of said switch in response to said plurality of packets; and
staggering said plurality of memory requests so that each of said plurality of memory requests occurs during a different one of a plurality of time slots.

15. The article of claim 14, wherein said transmitting operation comprises transmitting said plurality of packets through said control pipeline circuitry at a deterministic flow rate.

16. The article of claim 15, wherein said deterministic flow rate is based on a maximum arrival rate of said plurality of packets to said switch, and wherein a corresponding amount of said plurality of time slots are empty of any of said plurality of packets if an arrival rate of said plurality of packets is less than said maximum arrival rate.

17. The article of claim 16, wherein said deterministic flow rate is one of said plurality of packets per three of said plurality of time slots.

18. The article of claim 14, wherein said control pipeline circuitry comprises address resolution unit circuitry capable of requesting data from said memory in response to a type of each of said plurality of packets passing through said address resolution unit circuitry.

19. The article of claim 18, wherein said address resolution unit circuitry comprises Layer 2 source lookup (L2S) circuitry, Layer 2 destination lookup (L2D) circuitry, and Layer 2 Secondary lookup (L2SS) circuitry, said L2S circuitry making a first memory request for a first data packet during a first time slot, said L2D circuitry making a second memory request for a second data packet during a second time slot, and said L2SS circuitry making a third memory request for a third packet during a third time slot.

20. The article of claim 14, wherein said plurality of packets comply with an Ethernet communication protocol.
